(19) United States
(12) Patent Application Publication
(10) Pub. No.: US 2007/0049131 A1
(43) Pub. Date: Mar. 1, 2007

(54) Solder and method for applying same

(76) Inventors: Andre Jenrich, Leipzig (DE); Jakob Gillian, Seeshaupt (DE)

Correspondence Address: JORDAN AND HAMBURG LLP, 122 EAST 42ND STREET, SUITE 4000, NEW YORK, NY, 10168, US

(21) Appl. No.: 11/511,121

(22) Filed: Aug. 28, 2006

(30) Foreign Application Priority Data
Aug. 27, 2005 (DE) 10 2005 040 819.2

(51) Int. Cl. H01R 4/02

(52) U.S. Cl. 439/874

(57) ABSTRACT

An unsoldered solder is a hollow cylindrical sleeve for placing on the ends of electrical connectors to be soldered and on the ends of cables followed by heating and melting, i.e., soldering.

### BACKGROUND OF THE INVENTION

This invention relates to solders of known compositions and methods for application thereof to create an electrically conducting connection to an electrical connector or to or with electrical cables.

Such solders have been known for quite some time, as has their application to electrical connectors, such as to soldering tags or the like or to electrical cables. It is possible both to tin-plate them and to solder on a third electrical line.

What is disadvantageous in this is that in the past as a rule the solder had to be supplied manually with one hand as a strip from a roll and the other hand had to be used to operate the soldering device, e.g. the soldering iron, which is complicated. In addition, there is the risk that, despite melting the solder, if the soldering time is too short and consequently the heat given off by the soldering device is too low, a so-called cold soldering joint occurs without an electrical connection; the soldering process thus depends on the experience and talent of the technician and is thus not sufficiently precise.

The underlying object of the invention is therefore to provide a solder configuration and a method that is less complex to perform and that does not depend on the talent of the technician.

### SUMMARY OF THE INVENTION

According to the invention there is provided a solderable, i.e., unsoldered, solder in the form of a hollow cylindrical sleeve of a solder of conventional composition. The terms “solderable” or “unsoldered” are used herein to make it clear that the hollow cylindrical sleeve is a starting solder material, just as, for example, wires of solder material are known as solder starting materials for effecting soldering. Further, according to the invention, the sleeve is placed on an end of an electrical connector or cable, usually of copper, the sleeve then preferably being deformed so that it is temporarily held in place by a positive-fit or friction-fit effected by the deforming and then heated and melted to effect soldering.

### DETAILED DESCRIPTION OF THE INVENTION

Thus, the solder is inventively placed in the shape of a sleeve onto the electrical connector, e.g. soldering tag, or onto the end of an electrical cable and where necessary deformed, e.g., securely crimped, in this position e.g. by means of a tool. Then, during non-automated or only semi-automated soldering processes, the technician can devote his undivided attention to the actual soldering process, which is then less complex to perform. The solder in the shape of a sleeve and the method for applying it for soldered connectors is suitable with particular advantage for use in the automotive industry for panes of glass, especially panes of glass for motor vehicles.

In one advantageous further development of the invention, the sleeve has on its surface a coating which includes an optical indicator, such as a thermable decomposable dye, that acts thereon to effect a visual change, e.g. change in color, at a certain pre-specifiable temperature. Because of this, when the temperature thereof is correctly determined, when the visual change occurs it is possible to perform the soldering process without relying on the experience and talent of the technician and therefore to perform it with sufficiently greater precision so that not only manual but also non-automated or only semi-automated soldering is possible using the visual indication when the soldering temperature has been attained.

The sleeve may be provided with a coating including a flux. That coating is applied preferably as a glaze, i.e., the flux is briefly melted to form a hardened coating, i.e., a glaze.

The solder composition is preferably one from which a dimensionally stable but deformable sleeve can be formed, such as soldering tin.

1-11. (canceled)

12. Unsoldered solder suitable for placing on ends of electrical connectors to be soldered and on ends of cables to be soldered, comprising unsoldered solder in the form of a hollow cylindrical sleeve.

13. Unsoldered solder according to claim 12, further comprising a coating on an external surface of the sleeve.

14. Unsoldered solder according to claim 13, wherein the coating comprises a flux.

15. Unsoldered solder according to claim 14, wherein the coating comprises a glaze of the flux.

16. Unsoldered solder according to claim 14 or 15, wherein the coating comprises a visual indicator that effects a color change of the coating at a predetermined temperature.

17. Unsoldered solder according to claim 16, wherein the visual indicator comprises a thermally decomposable dye.

18. Unsoldered solder according to claim 12, 13, 14 or 15, wherein the sleeve comprises a dimensionally stable but deformable solder.

19. Unsoldered solder according to claim 18, wherein the solder is soldering tin.

20. Method for soldering to provide an electrically conducting connection to an electrical connector or to electrical cable, comprising placing a hollow cylindrical sleeve comprised of an unsoldered solder on an end of the electrical connector or cable and then heating the sleeve until it melts.

21. Method according to claim 20, further comprising, after placing the hollow cylindrical sleeve on an end of the electrical connector or cable, and before heating the sleeve until it melts, deforming the sleeve so that the sleeve is temporarily held in place on the connector end or cable end by a positive- or friction-fit.

22. Method according to claim 21, wherein the electrical connector or cable end on which the sleeve is placed is of copper.
